(19) United States
(12) Patent Application Publication
(10) Pub. No.: US 2015/0286800 A1
(43) Pub. Date: Oct. 8, 2015

(54) CLOUD-BASED SERVER FOR FACILITATING HEALTH AND FITNESS PROGRAMS FOR A PLURALITY OF USERS

(71) Applicant: Santana Row Venture LLC, San Jose, CA (US)

(72) Inventors: Sameer Kanagala, San Jose, CA (US); Suzanne Lai, San Jose, CA (US); Balazs Nagy, Boulder, CO (US)

(73) Assignee: Santana Row Venture LLC

(21) Appl. No.: 14/523,032

(22) Filed: Oct. 24, 2014

Related U.S. Application Data
(60) Provisional application No. 61/974,433, filed on Apr. 2, 2014.
(60) Provisional application No. 62/020,665, filed on Jul. 3, 2014.

(51) Int. Cl. G06F 19/00; G06Q 30/02

(52) U.S. Cl. CPC G06F 19/3475; G06F 19/3418; G06Q 30/0279

(57) ABSTRACT

With the widespread use smartphones, sensors, connected devices the volume of data generated by users is staggering. Cloud based systems allow the statistical evaluation of user data which is vital for analyzing trends but privacy remains a major concern. What's needed is a system that establishes trust by providing the user full control over his data by specifying what parts of the data, how, when and for how long is shared with a particular program sponsor or an ecosystem partner that can improve the outcomes of the program. While this will set the stage to reward each user for the relevant events and data that they collect., the key to making this a reality is establishing a system that also provides the convenience of a single marketplace for the user to engage multiple sponsors who may be interested in the user's data and for the program sponsors to engage multiple ecosystem partners that can improve program outcomes.

### PRIORITY CLAIM

This application claims the benefit under 35 U.S.C. Section 119(e) to U.S. Provisional Patent Application Ser. No. 61/974,433, filed on Apr. 2, 2014 and titled “Methods and Systems for Cloud Based Real Time Alerts and Insights for Medications,” and to U.S. Provisional Patent Application Ser. No. 62/020,665, filed on Jul. 3, 2014 and titled “Methods and Systems for Cloud Based Data Brokerage for Analytics with Goals and Rewards,” both of which are incorporated by reference herein.

### TECHNICAL FIELD

Disclosed herein is a cloud-based system that monitors events and data generated by a plurality of users and creates real-time alerts, rewards and insights derived from analytics based on the user data and various other events and databases. These analytics are shared with various entities with the user's permission and the user may be compensated for his or her data and also benefits from rewards driven by goals. The users generate events and data from sensors they use or by manually entering information into a database using a computing device. The information is derived from actionable alerts and insights and can also be automatically captured through the use of sensors, external events and databases that contain the user's information. The data from each user from all possible sources is made available for analytics and the user is eligible for compensation and rewards driven by goals and other criteria. The data types, possible motivation for data entry and events, possible sensors types and databases and derived alerts and insights along with the collection and delivery mechanisms are disclosed here.

### BACKGROUND OF THE INVENTION

With the widespread use of smartphones and the explosion of sensors and connected devices, users today are collecting an unprecedented amount of data on their health, activity, shopping, and other subjects. In addition, program sponsors today can share aggregate program data with an ecosystem of partners that can set goals, monitor, advise and influence the programs for better outcome.

What is needed is a system and method for rewarding each user for the relevant and actionable events and data that they collect. What is further needed is a system that creates a single convenient means, portal or marketplace for the users to engage multiple sponsors, challenges and causes that are interested in the user's data. What is further needed is a system that establishes trust by providing the user full control over de-identifying his data and controlling what parts of the data, when and for how long is shared with any particular sponsor, challenge or cause.

### SUMMARY OF THE INVENTION

One embodiment of the invention is related to a system that monitors events and data from each user and enables the user to participate in analytics and insights for a sponsor, challenge or a cause etc. while allowing the types and duration of data shared to be fully controlled by the user. The system allows sponsors, challenges and causes to engage with and obtain data from individual users and possibly provide compensation to the users and also implement rewards based on goals and other criteria to align the user's actions with the charter of the sponsor, challenge or cause. The system allows an ecosystem of partners to monitor and shape the program activities based on aggregate data and program specific messages. The system allows multiple ecosystem partners with one or more specialties to engage with the programs and be optionally compensated by the sponsors of the program. Examples of such ecosystem partners are weight-loss clinics that can help employee wellness programs achieve better results and financial advisors that can help corporate programs with financial security and retirement planning.

A variety of mechanisms are provided in the present invention to allow individual users to select and participate in a program from a sponsor, challenge or cause. The users may use smartphones, tablets and laptop or any internet ready device to select and consent to participate in a program.

A variety of mechanisms are provided in the present invention to allow each sponsor, challenge or cause to create a program and invite individual users to participate. The user may receive invitations about these programs on his smartphone, tablet, laptop or any internet ready device and also through email, postal, parcel and print based marketing campaigns.

A variety of mechanisms are provided in the present invention to allow each sponsor, challenge or cause to invite individual users to its program and for the user to select, review the terms and consent to these invitations. The user's consent is required per program before his data is shared with a sponsor, challenge or cause.

A variety of mechanisms are provided in the present invention to allow users to initially select and later change their preferences at any time about the type of information that should be shared. This allows all, none or a subset of information to be shared with each sponsor, challenge or cause for each program they offer.

A variety of mechanisms are provided in the present invention to allow users to revoke their consent at any time. This stops any of the user's data from being shared with the sponsor, challenge or cause for whose program the consent was revoked.

A variety of mechanisms are provided in the present invention to allow users to access the goals, incentives, scores and rewards offered by a program from a sponsor, challenge or cause. The user can select the goals that best suit him and receive any incentives, scores and rewards that are applicable. These goals, incentives, scores and rewards can all be accessed on the user's smartphone, tablet, laptop or any internet ready device and also through emails and other means including traditional mail and parcel services.

All information for each sponsor, challenge or cause is delivered using an API or similar method and only includes de-identified data from users who consented to participate in that program from that particular sponsor, challenge or cause.

An analytics dashboard is provided for each sponsor, challenge or cause. The dashboard only uses de-identified data from users who consented to participate in that program from that particular sponsor, challenge or cause.

A variety of mechanisms are provided in the present invention to allow program sponsors to select multiple ecosystem partners and make their products and services available to the program participants.

A variety of mechanisms are provided in the present invention to allow program sponsors to revoke any ecosystem partner and make their products and services unavailable to the program participants.

A variety of mechanisms are provided in the present invention to allow program participants to review the term and conditions of each ecosystem partner.

A variety of mechanisms are provided in the present invention to allow program participants to learn more about and select the products and services of each ecosystem partner.

A variety of mechanisms are provided in the present invention to allow program participants to discontinue using the products and services of each ecosystem partner.

A variety of mechanisms are provided in the present invention to allow ecosystem partners to monitor and shape the program activities based on aggregate data and program specific messages.

A variety of mechanisms are provided in the present invention to allow ecosystem partners to receive real-time notifications about the program participants, goals, milestones etc.

A variety of mechanisms are provided in the present invention to allow ecosystem partners to send real-time messages to the program participants to encourage, motivate and create behavioral change for better outcomes.

All information for each program is delivered to ecosystem partners using an API or similar method and only includes de-identified data from program participants.

An analytics dashboard is provided for each ecosystem partner. The dashboard only uses de-identified data from users who consented to participate in that program

In this system the motivation of a user to share his data can vary based on his preferences and the profile of the recipient of this data. A sponsor such as an employer will typically incentivize the user with compensation using a method that may be facilitated by this system or handled independently between the sponsor and the user. A challenge such as a local marathon may prompt the user to share data and receive rewards based on goals and also to improve the marathon through analytics. A cause like leukemia research may motivate the user to share data without any compensation or rewards and solely in the interest of research and finding a cure.

The following are some of the benefits the proposed system will provide to the users, ecosystem partners, sponsors, challenges and causes:
(1) Ensure all events and data generated by a user can be shared with multiple interested entities such as sponsors, challenges, causes and ecosystem partners.
(2) Ensure the user expressly consents to participate in the program from an individual sponsor, challenge and cause before his data is shared.
(3) Ensure the user can participate in one or more groups within a program
(4) Ensure the user can at any time revoke his consent to participate in a program from any sponsor, challenge and cause so that his data is no longer shared.
(5) Ensure only de-identified user data is shared.
(6) Ensure aggregate data from all the participating users within any program is shared.
(7) Ensure the user is in full control of what parts of his data, how, when and for how long it is shared and with whom.
(8) Ensure sponsors, challenges and causes can be created and promoted to users.
(9) Ensure that a user can belong to programs from multiple sponsors, challenges and causes concurrently.
(10) Ensure that programs created by a sponsor, challenge and cause can be joined by invitation only.
(11) Ensure that any sponsor, challenge and cause can engage users for multiple programs.
(12) Ensure that any program created by a sponsor, challenge and cause can have multiple groups with unique goals, rewards and reports for each group.
(13) Each group within a program may have a distinct charter and activities or multiple similar groups may just be setup to foster competition amongst groups.
(14) Ensure the sponsor, challenge and cause is notified of the consents and revocations by individual users.
(15) Provide a system for each sponsor, challenge or cause to implement a means for establishing goals and dispersing scores, reports and rewards to individual users.
(16) Provide a system for each sponsor, challenge or cause to implement a method for compensating users for their participation in a program and sharing their data.
(17) Provide a system for each user to agree to the terms and conditions before joining a program from a sponsor, challenge or cause.
(18) Provide a system for each program's aggregate data from all participants, analytics and metrics for participation and satisfaction etc. to be provided in real-time to the sponsor, challenge or cause.
(19) Provide a portal for each sponsor, challenge or cause to set goals and monitor data from all participants of a program.
(20) Provide a system for each sponsor, challenge or cause to send messages in real-time to the program participants.
(21) Provide a system for each sponsor, challenge or cause to receive real-time notifications about the program participants.
(22) Provide a system for each user to agree to the terms and conditions and acknowledge the role of ecosystem partners in the program and the aggregate data shared with them.
(23) Provide a system for each program to engage multiple ecosystem partners with various specialties and offerings.
(24) Provide a system for each program's aggregate data from all participants, analytics and metrics for participation and satisfaction etc. to be provided in real-time to the ecosystem partners involved in the program.
(25) Provide a portal for each ecosystem partner to set goals, advice and monitor data from all participants of a program.
(26) Provide a system for each program's ecosystem partners to receive real-time notifications about the program users.
(27) Provide a system for each program's ecosystem partners to send messages in real-time to the program users.

### SUMMARY OF THE INVENTION

With the widespread use of smartphones, sensors, and connected devices, the volume of data generated by users is staggering. Cloud-based systems allow the statistical evaluation of user data which is vital for analyzing trends but privacy remains a major concern. What's needed is a system that establishes trust by providing the user full control over his data by specifying what parts of the data, how, when and for how long is shared with a particular program sponsor or an ecosystem partner that can improve the outcomes of the program. While this will set the stage to reward each user for the relevant events and data that they collect., the key to making this a reality is establishing a system that also provides the convenience of a single marketplace for the user to engage multiple sponsors who may be interested in the user's data and for the program sponsors to engage multiple ecosystem partners that can improve program outcomes.

### BRIEF DESCRIPTION OF THE DRAWINGS

FIG. 1 is a schematic block diagram in accordance with one embodiment of the present invention.

FIG. 2 is a block diagram of a cloud-based system.

FIG. 3 depicts a method of creating and disseminating information to an ecosystem of users.

FIG. 4 depicts a screenshot of a user interface for creating a program.

FIG. 5 depicts a screenshot of a user interface on a computing device to provide options to a user.

FIG. 6 depicts a screenshot of a user interface on a computing device to allow a user to select a program.

FIG. 7 depicts a screenshot of a user interface on a computing device to allow a user to select sponsors.

FIG. 8 depicts a screenshot of a user interface on a computing device to allow a user to select options relating to Personal Health Records.

FIG. 9 depicts a screenshot of a user interface on a computing device to allow a user to select options relating to a Health Summary.

FIG. 10 depicts a screenshot of a user interface on a computing device for displaying data relating to medication adherence.

FIG. 11 depicts a screenshot of a user interface on a computing device to allow a user to select information to be shared with a cloud based server.

FIG. 12 depicts a block diagram of message dissemination using a cloud based server.

FIG. 13 depicts a screenshot of a user interface on a computing device to allow an individual to send a message to a group.

FIG. 14 depicts a screenshot of a user interface on a computing device to display a message.

FIG. 15 depicts a screenshot of a user interface on a computing device showing a dashboard with data collected from numerous users.

### DETAILED DESCRIPTION OF THE PREFERRED EMBODIMENTS

Embodiments of the inventions will now be described. For the purpose of this description, the individuals of this system whose data and events are being monitored and collected are referred to as users or participants. The use of the word “user” or “users” is not meant to limit the scope of the invention or to require any kind of doctor/user, employer/employee relationship or any other kind of medical or legal or other relationship with the individuals.

As used herein, the term “program” refers to any kind of activity, campaign or event including, without limitation corporate, research, charity, health, wellness and fitness. The scope of this invention is not limited by the type of program or the entity or organization.

As used herein, the terms “sponsor” , “challenge” and “cause” refers to the types of organizations including, without limitation corporate, research and charity. The scope of this invention is not limited by the type of organization or the program.

As used herein, the terms “ecosystem partner” refers to any organization that could benefit the program and its participants through better outcomes including but not limited to improved quality and lower costs. A partner can assist the sponsor of a program by providing services such as a fitness coaching or health food expertise. A partner can also assist the sponsor of a program by providing products such as athletic equipment or health food. The scope of this invention is not limited by the type of product or service offered by the ecosystem partners. An ecosystem partner may also be a sponsor himself who while offering programs of its own may also be acting as an ecosystem partner for other sponsors and helping their programs improve outcomes.

As used herein, the terms “group” refers to the groups defined within a program each of which may have a distinct charter and activities or may just be created to foster competition amongst groups within the program.

As used herein, unless expressly stated otherwise, “analytics” means insights derived from any meaningful patterns in data recorded or stored in the cloud based server and/or any external servers and databases. For example, average weight of users at a location based on its proximity to a gym, projected refill dates for medications based on user's side effects and medication adherence or any other valuable information derived from one or more medications in use by the user.

As used herein, unless expressly stated otherwise, “events” means signals and/or messages that are generated by the structures and devices described herein.

As used herein, unless expressly stated otherwise, “sensor” means a device capable of monitoring various physical, biometric and environmental parameters that is packaged as an individual system or is part of a system that performs other functions. Sensors can be packaged in wearables such as wristbands, watches, eye glasses and also smartphones, thermostats and automobiles etc. Sensors have the ability to generate suitable events and messages through its RF; IrDA (infrared); Bluetooth; ZigBee (and other variants of the IEEE 802.15 protocol); IEEE 802.11 (any variation); and ultrasound interfaces. These events and messages indicate the current, trending and other calculated values of parameters such as temperature, weight, heart rate, blood pressure, blood glucose, etc.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example,” rather than “model.” Although the figures may depict example arrangements of elements, additional intervening elements, devices, features, or components may be present in an embodiment of the invention.

For the sake of brevity, conventional techniques related to databases, signal processing, data transmission, network control, wireless networks and specifications, and other functional aspects of the systems (and the individual operating components of the systems) may not be described in detail herein. Furthermore, the connecting lines shown in the figure contained herein are intended to represent example functional relationships and/or physical couplings between the various elements. It should be noted that many alternative or additional functional relationships or physical connections may be present in an embodiment of the invention.

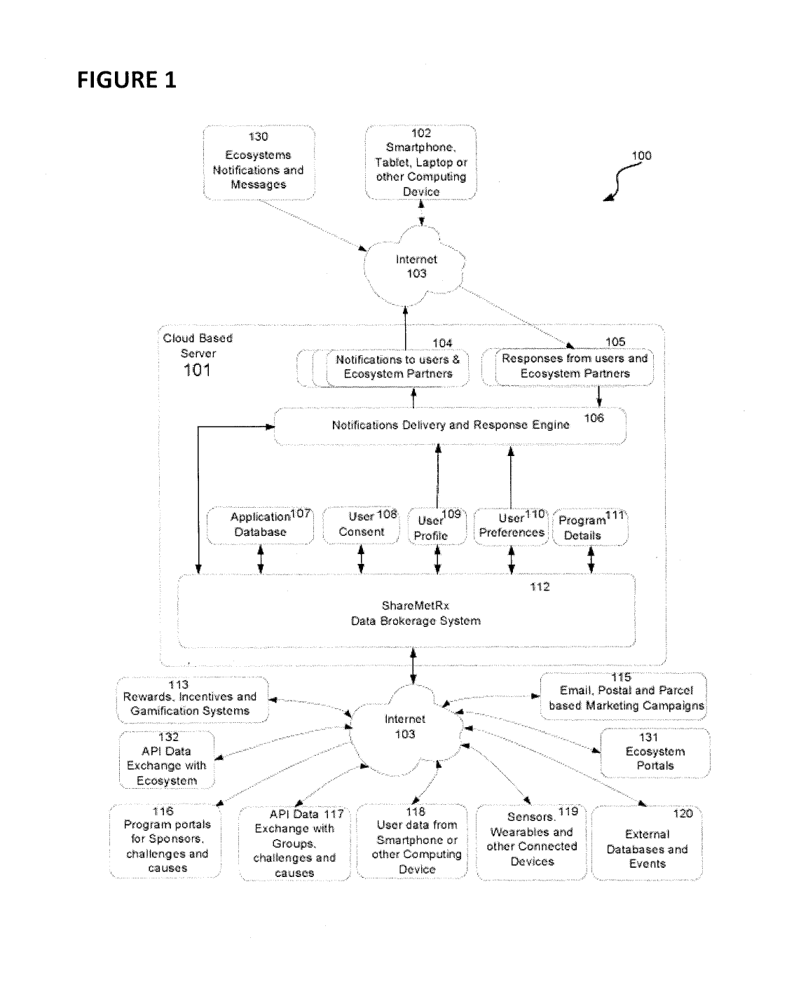

FIG. 1 depicts an embodiment of the invention. System 100 comprises cloud based server 101 coupled to the Internet 103.

Cloud based server 101 is also coupled to one or more computing devices 118. For purposes of the embodiments described herein, it will be assumed that computing devices 118 are operated by “users.”

Cloud based server 101 is coupled to one or more sensor devices 119. A sensor device is a device that monitors or measures a health or fitness characteristic of a human being, such as wearable monitors such as FitBit devices or blood pressure, temperature, pulse, weight, or activity monitors. For purposes of the embodiments described herein, it will be assumed that sensor devices 119 also are operated by “users.”

Cloud based server 101 is coupled to one or more external databases and sources of events 120.

Cloud based server 101 is coupled to one or more computing devices 131, which allows ecosystem partners and others to interact with programs using cloud based server 101. Computing devices 131 allow ecosystem partners, to advise, maintain, and monitor programs and also receive analytics and other information about the program.

Cloud based server 101 is coupled to one or more computing devices 116, which allow sponsors, and others to setup, maintain, and monitor programs and also receive analytics and other information about the program.

Cloud based server 101 is coupled to API interface 117, which enables communication using APIs with computing devices (such as computing device 116) operated by, sponsors and others who wish to exchange aggregate data with programs.

Cloud based server 101 is coupled to API interface 132, which enables communication using APIs with computing devices (such as computing device 131) operated by partners and others who wish to exchange aggregate data with programs.

Cloud based server 101 is coupled to one or more computing devices 113, which allow partners, sponsors, and others to provide rewards, incentives, badges, quizzes and gamification for a program.

Cloud based server 101 is coupled to one or more computing devices 115, which allow sponsors, partners and others to implement marketing campaigns that promote ecosystem partners or programs to users using email, postal, parcel, online, print and other methods.

Application database 107 can store events generated by other portions of cloud based server 101 or that are received from external sources. Insights derived from any meaningful correlation of such events with any other data available in the application database 107, and external databases 120 can in turn generate insights and alerts. An example of such an event is a medication recall event from an external source or an internally generated event for projected refill ordering dates for medications.

Internet 103 can utilize wireless or wired protocols, such as Cellular, 3G, 4G, LTE, RF; IrDA (infrared); Bluetooth; ZigBee (and other variants of the IEEE 802.15 protocol); IEEE 802.11 (any variation); ultrasound interfaces and specifications; or Ethernet.

Cloud based server 101 in the illustrated embodiment can be implemented as a cloud server using both public, private and hybrid cloud configurations. The cloud based server 101 continuously stores all the configuration and monitoring, and event data in a centralized application database 107 and communicates with the users, and multiple programs to share timely, appropriate and relevant alerts and insights based on the user's consent 108, user's profile 109, user's preferences 110 and program details 111. Cloud based server 101 in the illustrated embodiment implements all the security and data privacy safeguards to protect user's medical, financial or other critical records for both data in transit and data at rest. This server is compliant with the requirements of industry specific security standards and regulations such as HIPAA and PCI.

Cloud based server 101 in the illustrated embodiment implements a data brokerage system 112 that derives insights from meaningful correlation of all events and messages stored in the application database 107 and external databases and events 120. These analytics are made available to other functions within the cloud based server 101 such as the notification delivery and response engine 106 and are also provided to external systems in both real-time and historical formats using application programming interfaces (APIs) such as a representational state transfer (REST) API.

Cloud based server 101 receives all events and messages from external databases and events 120 using application programming interfaces (APIs) such as a representational state transfer (REST) API.

Cloud based server 101 does not share any data that can be used to identify a user. Instead, external databases and events 120, program portals 116, API data exchange 117, ecosystem portal 131 and ecosystem partner API data exchange 132 may be provided an aggregated view of the current users of the program using de-identified data. Events and messages from these external sources are used by the data brokerage system 112 to derive alerts and insights for individual users or program groups based on private information in the user's consent 108, user's profile 109, user's preferences 110 and program details 111. This preserves user privacy while still delivering timely and important alerts and insights.

For example, each user can be associated with an encrypted ID. All records regarding a user that is stored within application database 107 is associated with the user's encrypted ID. Sharing aggregate data and using encrypted IDs reports or data can be shared without compromising the user's privacy and allows the system to comply with HIPAA and other privacy requirements.

Cloud based server 101 in the illustrated embodiment implements a data brokerage system 112 that determines the alerts and insights per program based on the application database 107, notification delivery and response engine 106, user's consent 108, user's profile 109, user's preferences 110 and program details 111.

Data brokerage system 112 can update the user consent 108, user profile 109, application database 107 based on user's actions, an example of this is revoking consent based on the response from users and ecosystem partners 105 delivered by the notification delivery and response engine 106.

Data brokerage system 112 can update application database 107 based on ecosystem partners actions and messages. An example of this is queuing messages for the program participants based on the response from users and ecosystem partners 105 delivered by the notification delivery and response engine 106.

Data brokerage system 112 can update the program details 111 and application database 107 based on the program portal 116 which allows the program sponsors to make such changes, an example of this is extending the enrollment deadline for a program.

Data brokerage system 112 can update the program details 111 and application database 107 based on the ecosystem partners portal 131 which allows the ecosystem partners to make such changes, an example of this is to adjust the goals for a program.

The sponsor, challenge or cause that setup the program can access the results and analytics for the program from de-identified data using the analytics dashboard within the program portal 116 and also receive the aggregate, de-identified data for the program using the API data exchange 117.

The ecosystem partners associated with a program can access the results and analytics for the program from de-identified data using the analytics dashboard within the ecosystem partners portal 131 and also receive the aggregate, de-identified data for the program using the ecosystem partners API data exchange 132.

The sponsor, challenge or cause that setup the program can access the data for participation, satisfaction and other metrics for the program using the program portal 116 and also receive this de-identified data from the program using the API data exchange 117.

The ecosystem partners associated with a program can access the data for participation, satisfaction and other metrics for the program using the ecosystem partners portal 131 and also receive this de-identified data from the program using the ecosystem partners API data exchange 132.

Notification delivery and response engine 106 monitors the responses from users and ecosystem partners 105 and updates the data brokerage system 112. An example of this is a user response to join a program.

Notification delivery and response engine 106 monitors the responses from users and ecosystem partners 105 and updates the data brokerage system 112. An example of this is an ecosystem partner's notification and messages 130 to change the goals for a program or convey motivational messages.

Notification delivery and response engine 106 accesses the user's profile 109, user preferences 110 and delivers notifications to users and ecosystem partners 104 for alerts and also for offers, rewards and incentives for the program from the rewards, incentives and gamification systems 113 based on the user's group from program details 111. Examples of such notifications are a user receiving a notification of a reward for his group completing an activity, or an ecosystem partner receiving a notification about a milestone reached by a program group.

Cloud based server 101 in the illustrated embodiment also allows the user to configure any sensors and monitoring devices 119 he is using such as blood pressure, temperature, pulse, weight and activity monitors. Data from these devices is used to provide a holistic view of the user's health, wellness and fitness enabling the data brokerage system 112 to generate useful and timely alerts, analytics and insights based on the program details 111 and the user preferences 110. An example of this is a program that sets goals for physical activity by the user and provides rewards in return, the user preferences may however disallow the use of his activity data.

Cloud based server 101 can correlate the events and messages and location from each user's smartphone and computing devices 118 sensors and connected devices 119 and events and messages from external database 120 to create alerts and insights.

Cloud based server 101 delivers notifications over the internet 103 to computing devices 102 for alerts, offers, rewards and insights etc. computing devices 102 can be any device with a browser or one or more smartphones or tablets with an App (application) and GPS capability.

Computing devices 102 can use a browser or app to deliver these alerts, offers, rewards and insights etc. to the user based on his preferences such as email, SMS, smartphone App or browser. This provides users access to these notifications from anywhere and at any time.

In one embodiment of the invention, a partner, or sponsor uses the cloud based server 101 to access a program portal 116 and setup a new program and program details 111. The program portal 116 is also used to setup the rewards, goals and any gamification systems 113. An ecosystem partner uses the cloud based server 101 to access a ecosystem partner portal 131 and setup and update program details 111. The program portal 116 and ecosystem partner portal 131 are also used to setup the rewards, goals and any gamification systems 113. The cloud based server 101 sends out notifications 104 inviting its user's and ecosystem partners to join the program along with the details. The cloud based server 101 also sends out notifications 104 containing motivational messages, quizzes and challenges that are received from ecosystem partner's notification and messages 130 via the responses from users and ecosystem partners 105 and the notification delivery and response engine 106. External marketing campaigns 115 are also used to reach users similarly. Each willing user's consent 108 is updated and the user can update preferences 110 and the user profile 109 is updated with program specific items. As events and data are collected form each user from his smartphone 118 and sensors 119 the data brokerage system 112 will consult the user consent 108, user preferences 110 and program details 111 and decide whether all, none or some of the user's data can be used for the program and will then update the application database 107 accordingly. The sponsor, challenge or cause that setup the program can access the results and analytics for the program using the program portal 116 and also receive the aggregate, de-identified data for the program using the API data exchange 117. The ecosystem partners associated with the program can access the results and analytics for the program using the ecosystem partners portal 131 and also receive the aggregate, de-identified data for the program using the ecosystems partners API data exchange 132. For each active program the cloud based server will consult the application database 107, user consent 108, user profile 109, user preferences 110 and rewards and incentives 113 to determine if any notifications should be sent to the user and if required will send any alerts, rewards, incentives etc. to the user from the notification delivery and response engine 106. The program can have a start date and time, stop date and time as well as enrollment start date and time and an enrollment stop date and time etc., these will cause the cloud based server 101 and the data brokerage system 112 to take appropriate actions and update the user profile 109, program data 111 and also inform the user and any external systems of the change in status for the program.

Computing devices 102, 113, 115, 116, 118, 119, 131, and any other computing devices referred to herein each can be one or more computerized devices each comprising one or more processors, memory, non-volatile storage, and a network interface that can be coupled to the Internet 103, such as a desktop, notebook, server, appliance, smartphone, tablet, or other networked device.

Cloud based server 101 is one or more computing device comprising one or more processors, memory, non-volatile storage, and a network interface that can be coupled to the Internet 103.

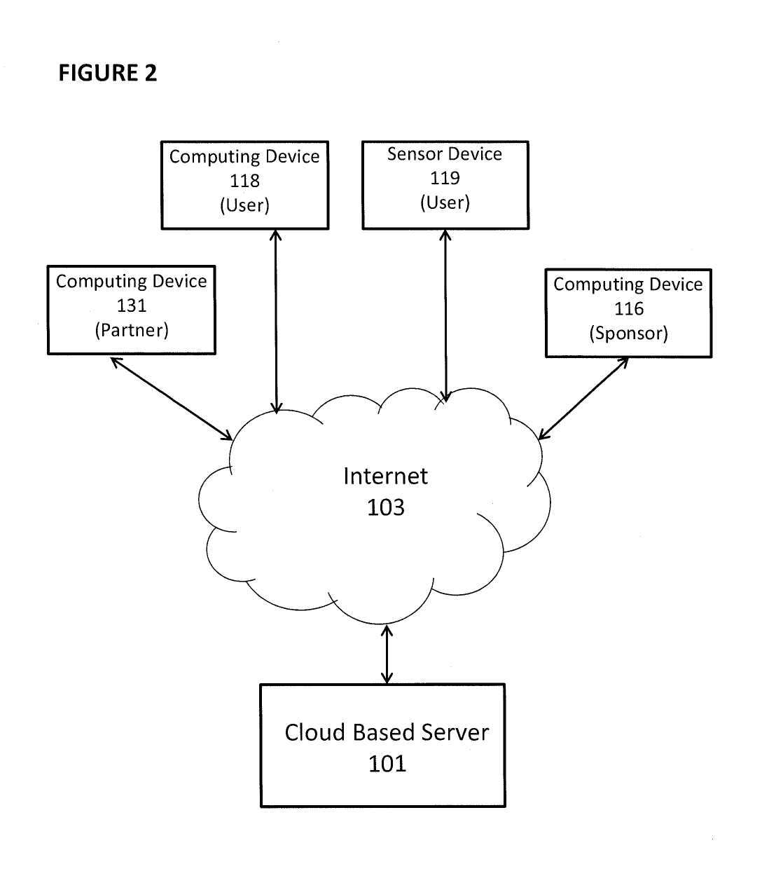

With reference to FIG. 2, a high-level view of the system 100 of FIG. 1 is depicted. Three different types of people utilize their computing devices to interact with cloud-base server: partner, sponsor, and user.

An sponsor (such as an HR manager who works for the employer of a user) operates computing device 116 and communicates with cloud-based server 101 over Internet 103. The sponsor can be an employee of a company that wishes to implement a health and fitness program for the employees of the company. The company employees (e.g., “Acme Corporation Employees”) can participate in programs (e.g., “Acme Weight Loss Program”).

A partner (such as a fitness coach) operates computing device 131 and communicates with cloud-based server 101 over Internet 103. A partner is a person who provides services to a program, such as a fitness coaching or health food expertise. A partner may also provide products that are valuable to Users, such as a monitoring device or a sports drink.

A user is a participating employee. A user operates computing device 118 and sensor device 119 and communicates with cloud-based server 101 over Internet 103.

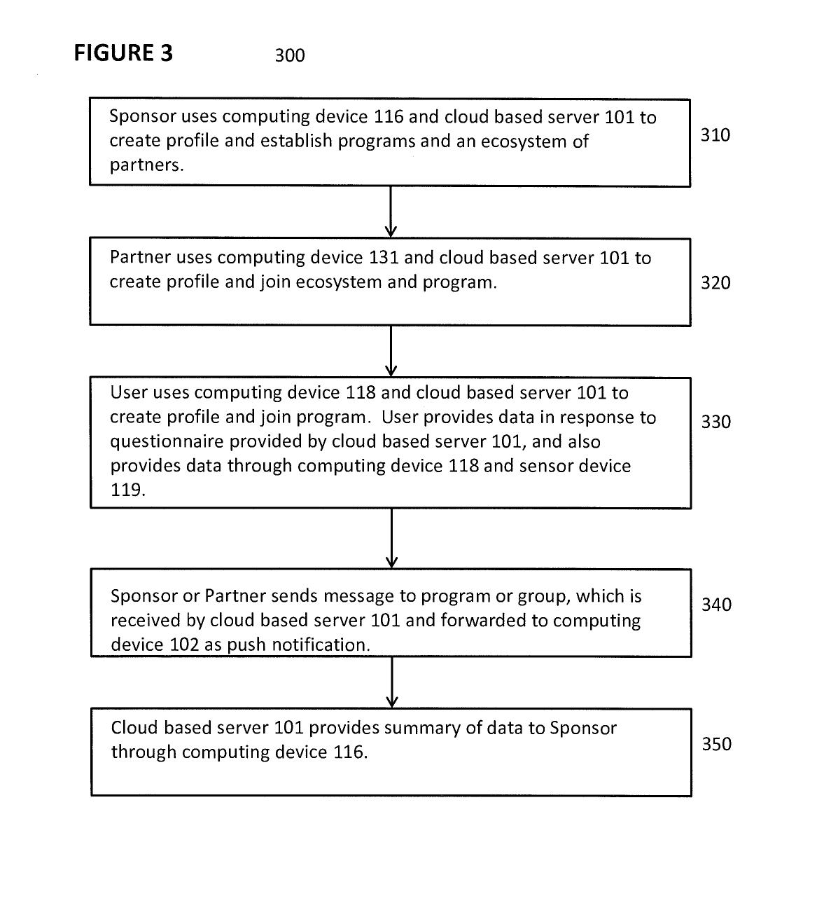

With reference to FIG. 3, a method 300 is depicted for utilizing the embodiments of FIGS. 1 and 2. A sponsor uses computing device 116 and cloud based server 101 to create a profile and establish an ecosystem of partners and one or more programs (step 310). Through this step, Sponsor identifies the group of people who are eligible to participate (e.g., all employees of Acme Corporation) and creates programs groups that will be used by the program. Examples of program groups include: lifestyle management programs such as activity and exercise programs and outcomes based programs such as weight loss, lowering blood pressure, lowering cholesterol, etc. Sponsor can cause cloud based server 101 to send invitations to individuals (such as users, partners) to join the program or ecosystem. Cloud based server 101 creates a unique ID for the program and a unique ID for each program group, and upon joining associates those IDs with the encrypted IDs of each user who is in that program and group, respectively.

A partner uses computing device 131 and cloud based server 101 to create a profile and join an ecosystem and one or more programs (step 320). Partner typically will be invited by cloud based server 101 to join the ecosystem. For example, Acme Corporation might hire a fitness coach to be a partner for a program or program group. In the alternative, a sponsor or user can find a partner within the system and elect to follow or connect with that partner.

User uses computing device 118 and cloud based server 101 to create profile and join ecosystem and program. A user is an individual who satisfies the criteria for the program and program group established by Sponsor (e.g., employees of Acme Corporation, or employees of Acme Corporation who wish to lose weight).

The user provides data in response to questionnaire provided by cloud based server 101, and the user also provides data through computing devices 118 and sensor devices 119 (step 330). This is the first stage in which cloud based server 101 collects health and fitness data. Examples of the types of data that can be collected during this stage include: height, weight, gender, existing conditions, blood pressure, heart rate, glucose level, body mass index, current medications, cholesterol, heart rate, blood oxygen level, sleep patterns, steps, distance, elevation, location, calories, and health goals.

A sponsor or partner sends a message to a program, which is received by cloud based server 101 and forwarded to computing device 102 as push notification (step 340). This is the primary mechanism by which goals are set, challenges are issued, rewards, badges, quizzes are provided, and games are established. For example, a Sponsor might send the message “Welcome to the Acme Corporation Weight Reduction Program,” a Partner might send the message “Our goal for this week is to lose one pound,” or a Partner might send the message “Purchase a heart rate monitor for $10 by clicking on this link.”

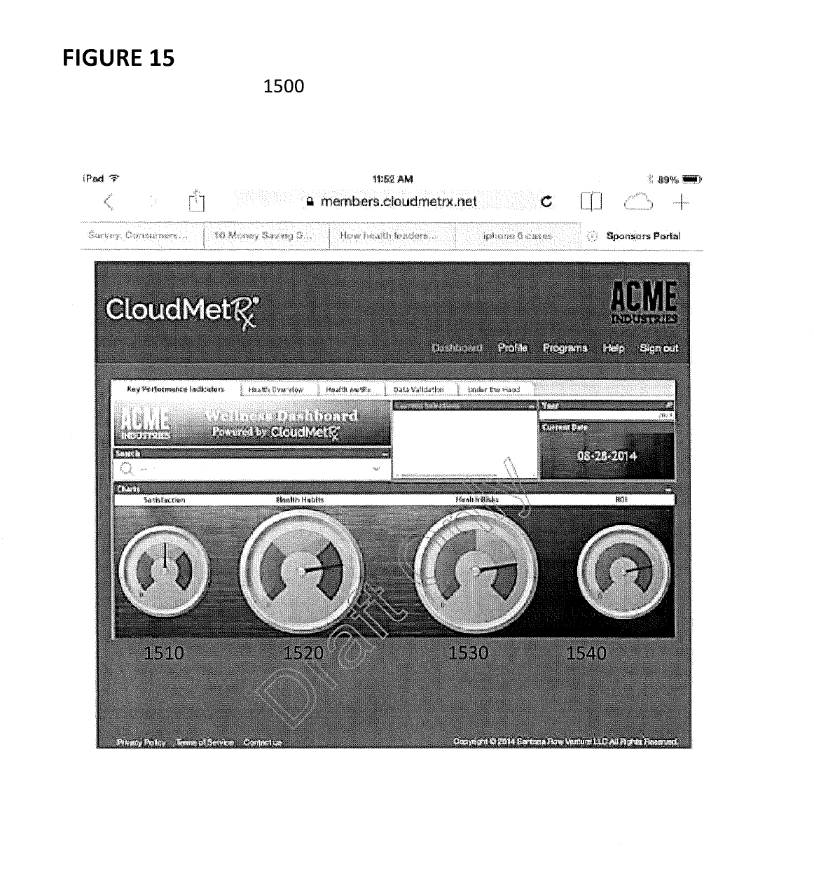

Cloud based server 101 provides a summary of data from users to Sponsor through computing device 116 (step 350). Cloud based server 101 can aggregate the de-identified data collected from numerous users and can present a report on that data, as shown, for example, in FIG. 15

Further details regarding the operation of programs and ecosystem partners will now be described.

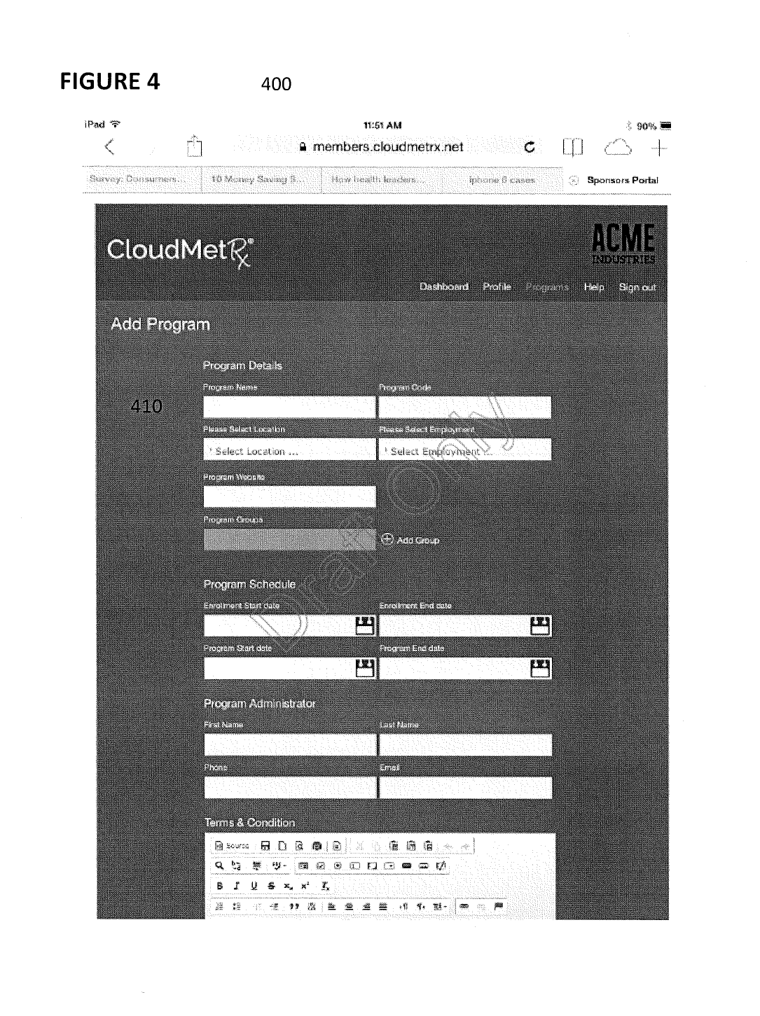

FIG. 4 depicts exemplary screenshot 400 generated by cloud based server 101 on computing device 116 operated by a sponsor. Screenshot 400 comprises input devices (such as text boxes, menu items, etc.) that are used by a sponsor to establish a program. For example, and HR manager for the sponsor Acme Company might set up a program for Weight Loss within Acme Company.

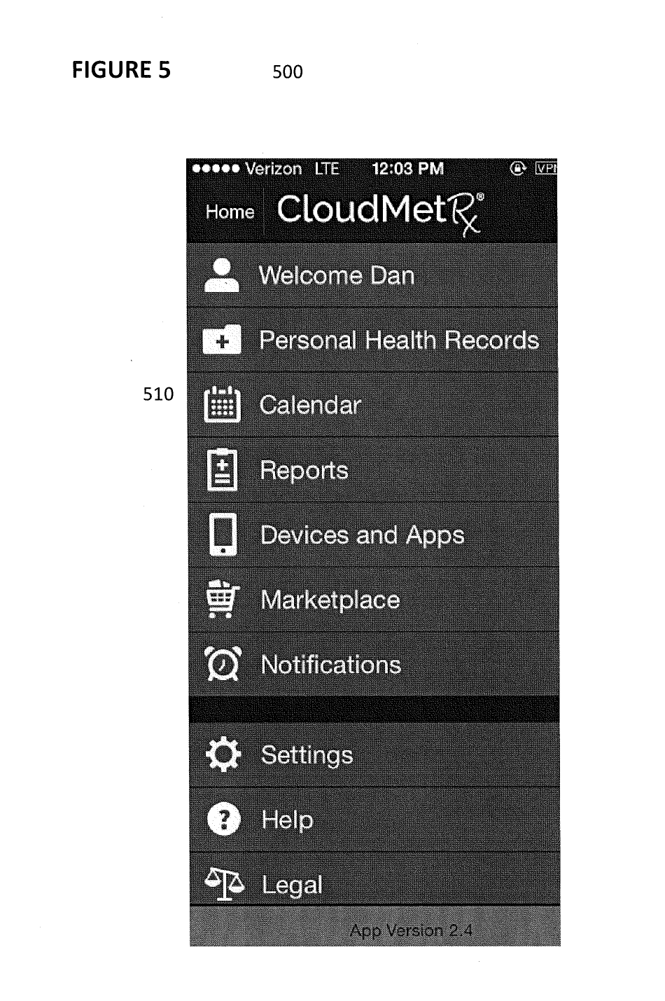

FIG. 5 depicts exemplary screenshot 500 generated by computing device 118 operated by a user, who in this example is an employee of the sponsor Acme Company. Screenshot 500 comprises input devices that provide the following functions: Personal Health Records, Calendar, Reports, Devices and Apps, Marketplace, Notifications, Settings, Help, and Legal.

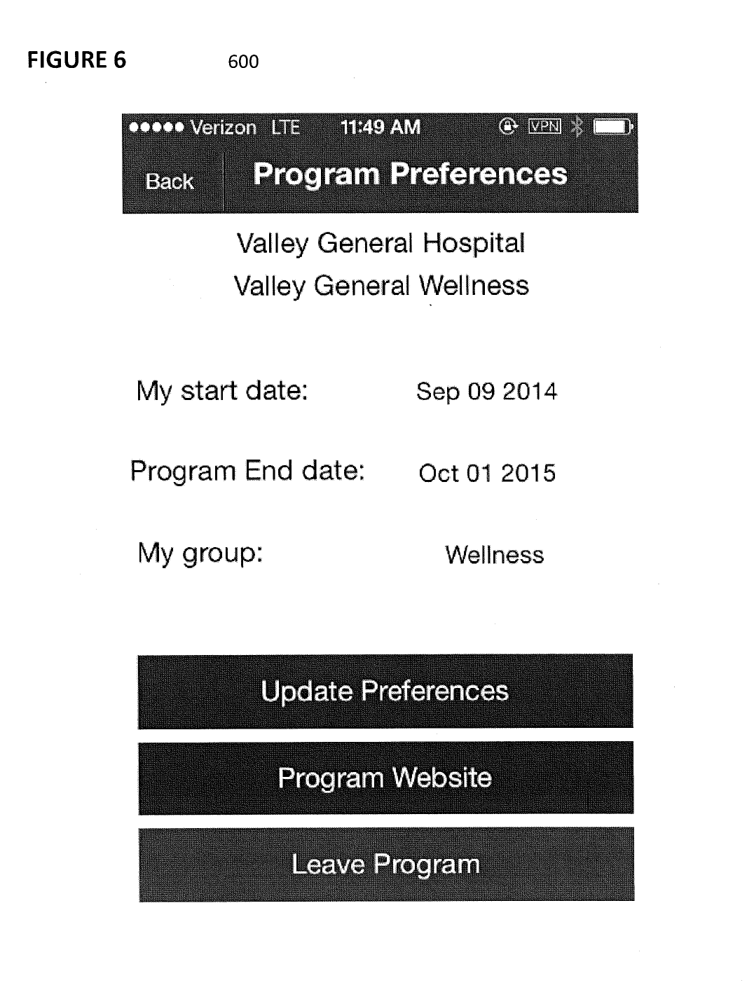

FIG. 6 depicts exemplary screenshot 600 generated by computing device 118 operated by the user. Screenshot 600 depicts information regarding the program that was set up in FIG. 3.

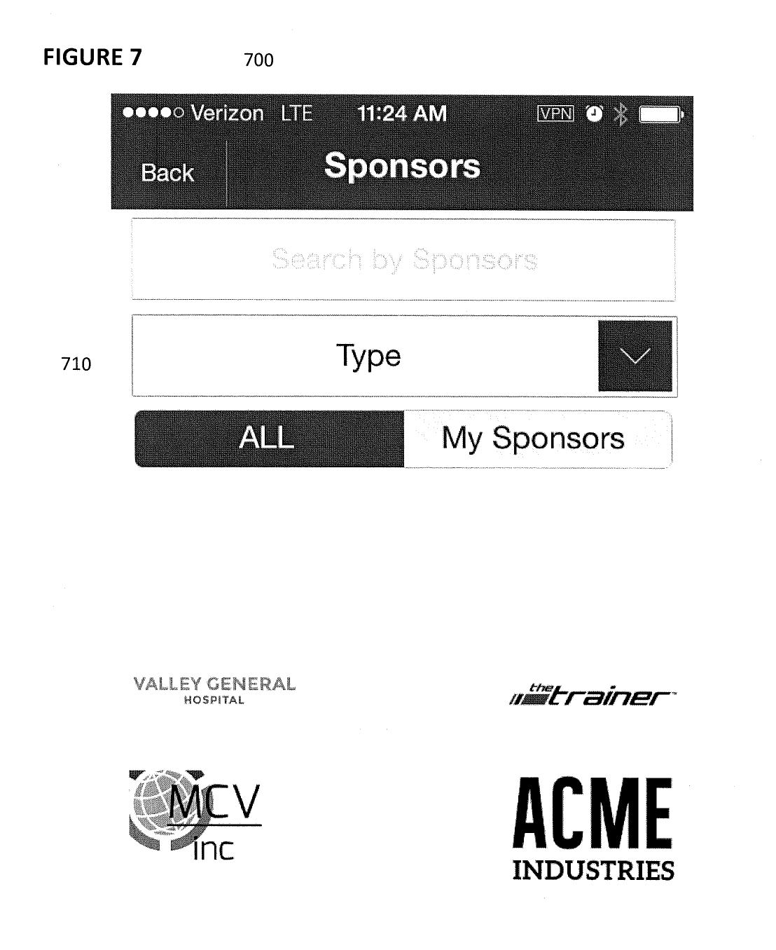

FIG. 7 depicts exemplary screenshot 700 generated by computing device 118 operated by the user. Screenshot 700 contains input devices 710 that enables the user to select sponsors, such as employers, local marathons and charity causes who are offering programs

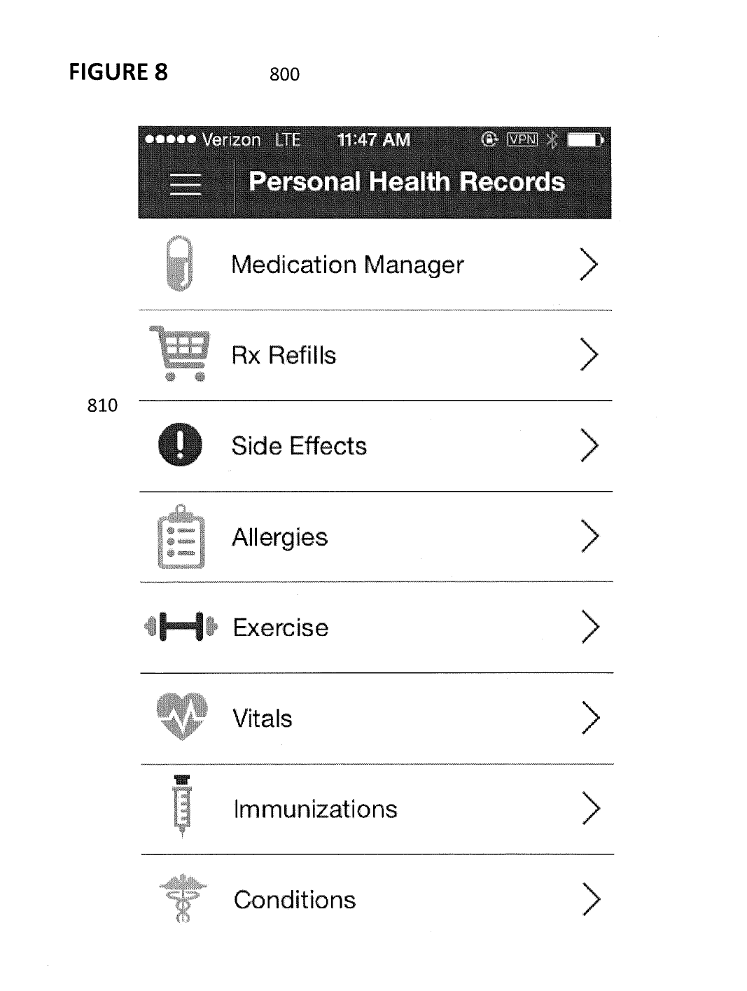

FIG. 8 depicts exemplary screenshot 800 generated by computing device 118 operated by the user when the user selects the “Personal Health Records” option of FIG. 5. Screenshot 800 comprises input devices 810 that allows the user to select the following functions: Medication Manager, Prescription Refills, Side Effects, Allergies, Exercise, Vitals, Immunizations, and Conditions.

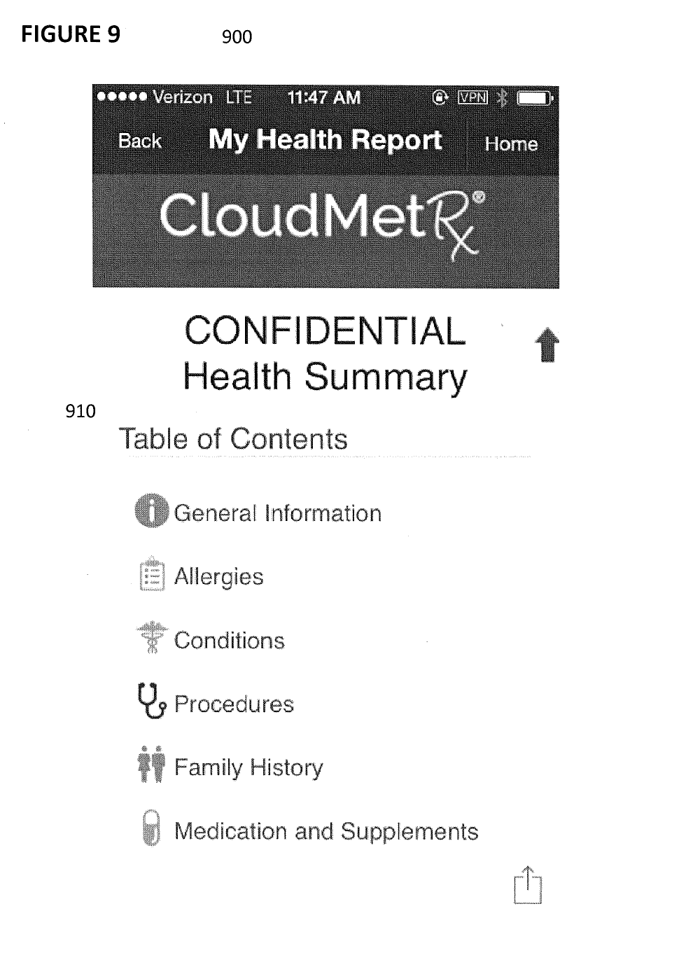

FIG. 9 depicts exemplary screenshot 900 generated by computing device 118 operated by the user. Screenshot 900 contains input devices 910 that allow the user to select the following functions: General Information, Allergies, Conditions, Procedures, Family History, Medication and Supplements.

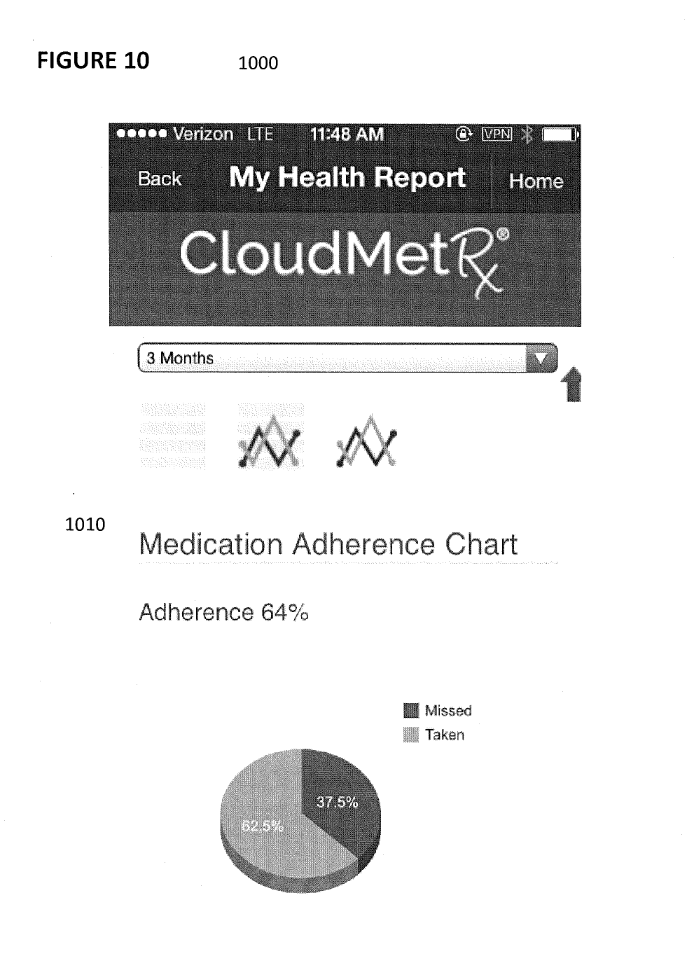

FIG. 10 depicts exemplary screenshot 1000 generated by computing device 118 operated by the user. Exemplary screenshot 1000 comprises data presentation 1010 that indicates, for example, the user's medication adherence.

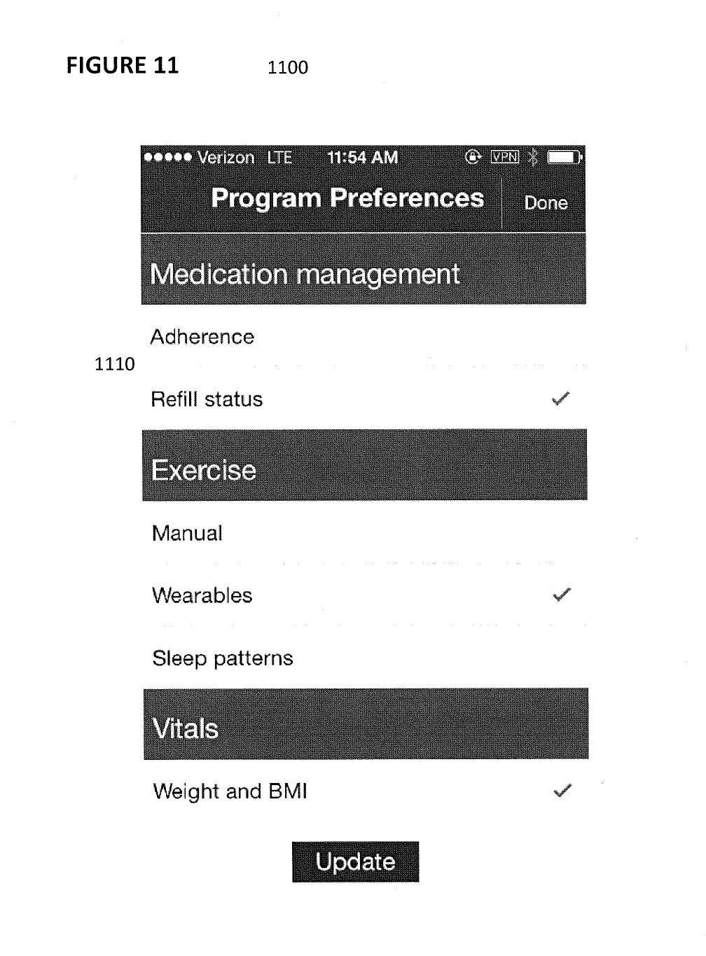

FIG. 11 depicts exemplary screenshot 1100 generated by computing device 118 operated by the user. Screenshot 1100 comprises input devices 1110 that allow the user to identify the types of information that is to be shared with cloud based server 101 and which information is not to be shared. This can be done, for example, for the following: medication management (adherence and refill status), exercise (manual, wearables, and sleep patterns), and vitals (weight and body mass index).

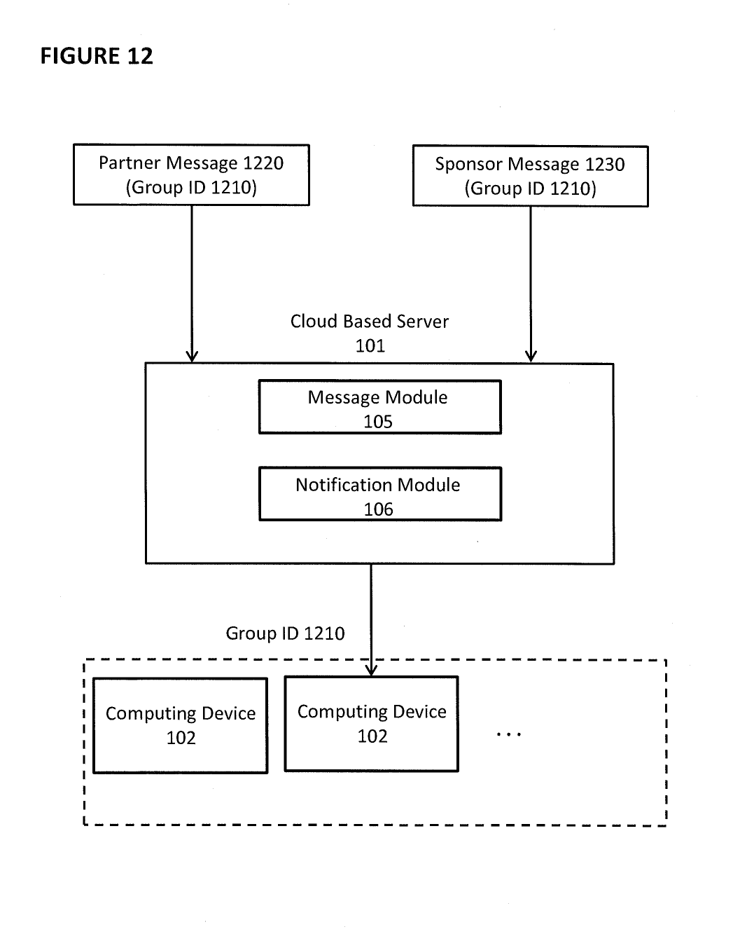

FIG. 12 depicts a method for propagating messages to users within an ecosystem or program. A partner generates message 1220 using computing device 131. A sponsor generates message 1230 using computing device 116.

Message 1220 and message 1230 each can be a tweet, an email, an instant message, an SMS or MMS message, or any other communication. Message 1220 and message 1230 each is directed to group ID 1210. For example, group ID 1210 can indicated as the recipient of the communication or as the subject line of the communication.

Cloud based server 101 receives message 1220 and message 1230. Message module 105 processes message 1220 and message 1230 and parses group ID 1210 to determine the individuals who are part of the group (such as users of a program) identified by group ID 1210. Notification module 106 then sends message 1220 and message 1230 (or portions thereof) to the members of the group identified by group ID 1210. In this example, message 1220 and message 1230 each are sent to various instances of computing device 102 as a tweet, an email, an instant message, an SMS or MMS message, or any other communication.

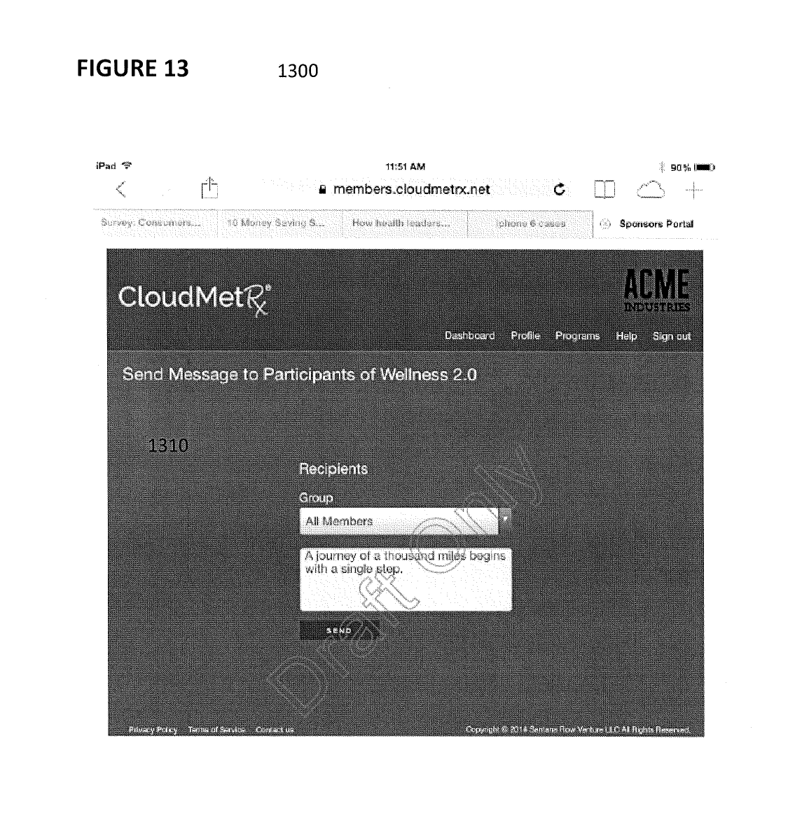

FIG. 13 depicts exemplary screenshot 1300 generated by computing device 116 operated by the sponsor, computing device 131 operated by a partner. Screenshot 1300 comprises input devices 1310 that enable the sponsor or partner to generate and send a message (such as message 1220 or 1230) to a group.

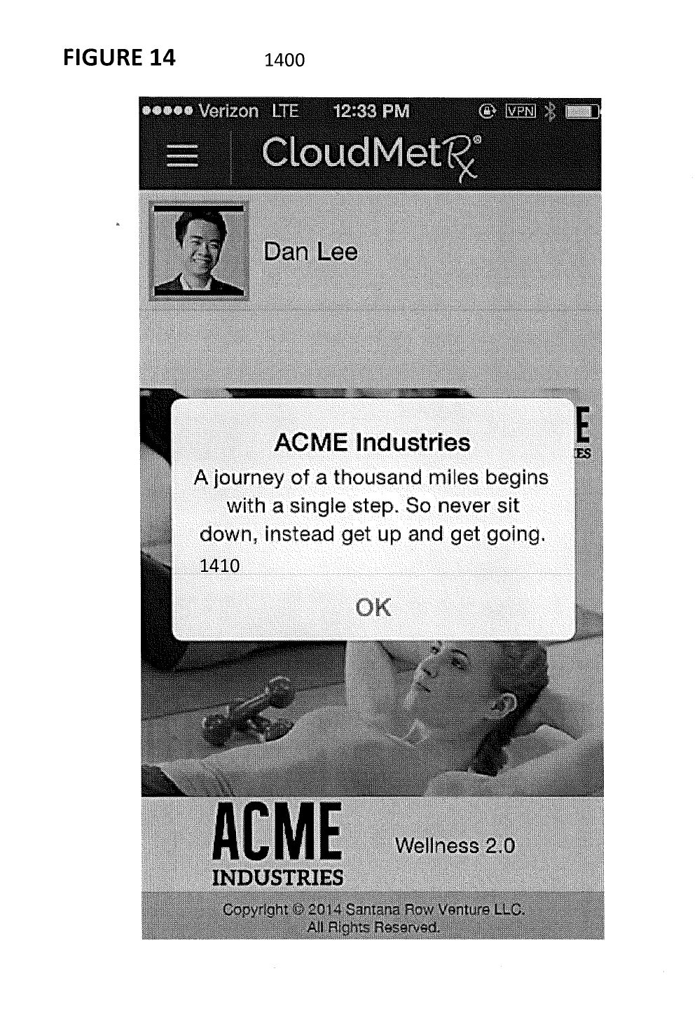

FIG. 14 depicts exemplary screenshot 1400 generated by computing device 102 operated by the user. Screenshot 1400 displays the message 1410 generated in FIG. 13 (such as message 1220 or message 1230).

FIG. 15 depicts exemplary screenshot 1500 generated by computing device 116 operated by the sponsor. Screenshot 1500 displays a summary of aggregated data collected from the users within a particular program or program group. For example, summary graphic 1510 depicts overall user satisfaction, summary graphic 1520 depicts health habits, summary graphic 1530 depicts health risks, and summary graphic 1540 depicts return-on-investment (ROI) for the program.

Health habits, health risks, and ROI are calculated using the following algorithms Health habits are calculated from factors such as immunizations, activity level, sleep patterns, medications adherence, etc. Health risks are calculated from factors such as smoking, alcohol use, obesity, hypertension, diabetes, etc. ROI is derived from current healthcare spending, absenteeism, disability claims, and projected healthcare savings from lowering health risks. Certain health habits such as medication adherence when improved lead to immediate lowering of health risks, while other like improved activity level may improve health risks in the long run.

What is claimed is:

1. A method for gathering and reporting health data for an ecosystem of users, comprising:
generating, by a cloud-based server, an ecosystem comprising a set of users;
generating, by the cloud-based server, a program for improving a health characteristic;
associating, by the cloud-based server, a subset of the set of users with the program;
obtaining a first set of data relating to the health characteristic, by the cloud-based server, from computing devices operated by the subset of the set of users;
obtaining a second set of data relating to the health characteristic, by the cloud-based server, from health monitoring devices operated by the subset of the set of users; and
providing a report, by the cloud-based server, based on the first set of data and the second set of data.

2. The method of claim 1, wherein the health characteristic is weight.

3. The method of claim 1, wherein the health characteristic is blood pressure.

4. The method of claim 1, wherein the health characteristic is cholesterol.

5. The method of claim 1, wherein the health characteristic is blood glucose level.

6. The method of claim 2, wherein the health monitoring devices comprise scales.

7. The method of claim 3, wherein the health monitoring devices comprise sphygmomanometers.

8. The method of claim 1, wherein the step of generating, by the cloud-based server, a program for improving a health characteristic is performed in response to a command from a partner.

9. The method of claim 8, further comprising: setting a goal, by the cloud-based server in response to a command from a partner, for users associated with the program.

10. The method of claim 1, further comprising:
associating, by the cloud-based server, a partner with the program;
receiving, by the cloud-based server, a message from a partner; and
transmitting a notification, by the cloud-based server, comprising the message to the subset of users.

11. The method of claim 10, wherein the notification comprises an SMS or MMS message or a push notification.

12. The method of claim 10, wherein the notification comprises an email.

13. The method of claim 1, wherein the report comprises data indicating health habits and health risks as to the subset of users and a return on investment as to the program.

14. A cloud-based server configured to:
generate a program for improving a health characteristic for a set of users;
obtain a first set of data relating to the health characteristic from computing devices operated by the set of users and a second set of data relating to the health characteristic from health monitoring devices operated by the set of users; and
provide a report based on the first set of data and the second set of data.

15. The server of claim 14, wherein the health characteristic is weight.

16. The server of claim 14, wherein the health characteristic is blood pressure.

17. The server of claim 14, wherein the health characteristic is cholesterol.

18. The server of claim 14, wherein the health characteristic is blood glucose level.

19. The server of claim 15, wherein the health monitoring devices comprise scales.

20. The server of claim 16, wherein the health monitoring devices comprise sphygmomanometers.

21. The server of claim 14, wherein the cloud-based server is configured to generate a program for improving a health characteristic for a set of users in response to a command from a partner.

22. The server of claim 21, further comprising: wherein the cloud-based server is configured to set a goal in response to a command from a partner for users associated with the program.

23. The server of claim 14, wherein the server is further configured to: receive a message from a partner associated with the program and transmit a notification comprising the message to the set of users.

24. The server of claim 23, wherein the notification comprises an SMS or MMS message or a push notification.

25. The server of claim 23, wherein the notification comprises an email.

26. The server of claim 14, wherein the report comprises data indicating health habits and health risks as to the subset of users and a return on investment as to the program.
